(19) United States
(12) Patent Application Publication
(10) Pub. No.: US 2018/0083429 A1
(43) Pub. Date: Mar. 22, 2018

(54) STRIPPING APPARATUS

(71) Applicant: HONDA MOTOR CO., LTD., Tokyo (JP)

(72) Inventors: Ryuzo Sakamoto, Tochigi (JP); Kenichi Omagari, Tochigi (JP); Kenichi Ono, Tochigi (JP)

(21) Appl. No.: 15/706,803

(22) Filed: Sep. 18, 2017

(30) Foreign Application Priority Data
Sep. 20, 2016 (JP) 2016-182860

(51) Int. Cl. H02G 1/12; H01B 15/00

(52) U.S. Cl. CPC H02G 1/1253; H01B 15/005

(57) ABSTRACT

A stripping apparatus and a stripping station capable of reducing cycle time for steps of stripping an insulation coating from a conducting wire material are provided. A stripping apparatus configured to strip a film WL off a long workpiece W of which outer periphery is coated with the film WL, includes: a cutting blade configured to move up and down in a direction orthogonal to an axial direction of the workpiece W; an upper mold having the cutting blade; a lower mold supporting the workpiece W; and a workpiece rotation mechanism configured to rotate the workpiece W by a predetermined angle around a rotational axis C1 parallel to an axial center of the workpiece W in synchronization with an upward movement and/or a downward movement of the upper mold.

This application is based on and claims the benefit of priority from Japanese Patent Application No. 2016-182860, filed on 20 Sep. 2016, the content of which is incorporated herein by reference.

### BACKGROUND OF THE INVENTION

### Field of the Invention

The present invention relates to a stripping apparatus.

### Related Art

An apparatus that strips insulation coating and cuts conducting wire material each time an insulation-coated conducting wire material is fed to manufacture a coil segment has been conventionally known in the art (See Patent Document 1, for example). Such an apparatus repeats a feeding step, a stripping step, a cutting step, and a stripping position changing step.

Patent Document 1: Japanese Patent No. 5681248

### SUMMARY OF THE INVENTION

The apparatus disclosed in Patent Document 1 is placed into a standby state during a step of feeding a conducting wire material, and does not perform processing steps, such as a step of stripping insulation coating, a step of cutting a conducting wire material. Accordingly, it takes time to complete the processing of a conducting wire material.

In view of the above problem, an object of the present invention is to provide a stripping apparatus and a stripping station that reduce cycle time for steps of stripping insulation coating from a conducting wire material.

To achieve the above object, a stripping apparatus (e.g. a stripping apparatus 10) is provided configured to strip a film (e.g. an insulation coating WL described below) off a long workpiece (e.g. a conducting wire material W described below) of which outer periphery is coated with the film, the stripping apparatus including a cutting blade (e.g. a punch 153 described below) configured to move up and down in a direction orthogonal to an axial direction of the workpiece, an upper mold (e.g. an upper mold 150 described below) having the cutting blade, a lower mold (e.g. a lower mold 110 described below) supporting the workpiece, and a workpiece rotation mechanism (e.g. a workpiece rotation mechanism 21 described below) configured to rotate the workpiece by a predetermined angle around a rotational axis (e.g. a rotational axis C1 described below) parallel to an axial center of the workpiece in synchronization with an upward movement and/or a downward movement of the upper mold.

With this configuration, the workpiece is rotated by a predetermined angle during the time of the upward movement of the cutting blade or the time of the processing, thus only the stroke time for moving the upper mold and the time for rotating the workpiece are included in a standby time in which no processing is performed, thereby reducing the cycle time.

In the stripping apparatus, the workpiece rotation mechanism includes a supporting member (i.e. a supporting member 211 described below) that is rotatable while supporting the workpiece, a rotational pin (i.e. a rotational pin 213 described below) configured to move vertically in synchronization with a vertical movement of the upper mold, a rotational-pin urging member (i.e. a spring 214 described below) configured to urge the rotational pin toward the supporting member, a fixed pin (i.e. a fixed pin 215 described below) of which vertical position is fixed relative to the supporting member; a fixed-pin urging member (i.e. a spring 216 described below) configured to urge the fixed pin toward the supporting member, and protrusions (i.e. protrusions 212 described below) provided on a periphery of the supporting member, each of the protrusions including a pin sliding surface (i.e. a pin sliding surface 2121 described below) extending radially outwards, away from a rotational axis of the supporting member gradually from a downstream side to an upstream side of a rotation direction of the workpiece, and a cut-away shaped pin engagement part (i.e. a pin engagement part 2122 described below) disposed at an upstream end of the pin sliding surface in a rotation direction of the supporting member and configured to engage with the rotational pin or the fixed pin.

With this configuration, when the upper mold moves upward, the rotational pin moves upward in synchronization with the movement of the upper mold. The rotational pin presses the pin engagement part upward to rotate the supporting member. While the fixed pin slides along the pin sliding surface, the spring serving as a fixed-pin urging member is compressed, then the fixed pin is engaged with the pin engagement part to prevent backflow (backward rotation of the supporting member). The rotation of the supporting member stops and the upper mold and the rotational pin are lowered. The workpiece is subjected to the processing again at the rotated position so that a side surface different from the side surface that has been processed is processed. In other words, the movement of the upper mold and the rotation of the workpiece can be synchronized with each other with a simple configuration. The rotation angle can be adjusted by changing the number of the protrusions and the size of the supporting member.

The present invention can provide a stripping apparatus and a stripping station capable of reducing cycle time for steps of stripping the insulation coating of a conducting wire material.

### BRIEF DESCRIPTION OF THE DRAWINGS

FIG. 1 is a schematic view of a stripping station according to a first embodiment of the invention;

FIG. 2 is a schematic sectional view of a stripping apparatus according to the first embodiment of the invention;

FIG. 3 is a schematic sectional view of a workpiece rotation mechanism of the stripping apparatus according to the first embodiment of the invention;

FIG. 4 is a schematic sectional view of an eccentric mechanism of the workpiece rotation mechanism of the stripping apparatus according to the first embodiment of the invention;

FIG. 5 is a schematic sectional view showing a state in which the stripping apparatus according to the first embodiment of the invention strips insulation coatings on first side surfaces of conducting wire materials;

FIG. 6 is a schematic sectional view showing a state in which the stripping apparatus according to the first embodiment of the invention strips insulation coatings on fourth side surfaces of the conducting wire materials;

FIG. 7 is a schematic sectional view showing a state in which the stripping apparatus according to the first embodiment of the invention strips insulation coatings on second side surfaces of the conducting wire materials;

FIG. 8 is a schematic sectional view showing a state in which the stripping apparatus according to the first embodiment of the invention strips insulation coatings on third side surfaces of the conducting wire materials;

FIG. 9 is a schematic sectional view showing the state before positioning the conducting wire materials in the vertical direction when the stripping apparatus according to the first embodiment of the invention strips the insulation coatings on the first side surfaces of the conducting wire materials;

FIG. 10 is a schematic sectional view showing the state after positioning the conducting wire materials in the vertical direction when the stripping apparatus according to the first embodiment of the invention strips the insulation coatings on the first side surfaces of the conducting wire materials;

FIG. 11 is a schematic sectional view showing a state in which the insulation coatings on the first side surfaces of the conducting wire materials have been stripped by the stripping apparatus according to the first embodiment of the invention;

FIG. 12 is a schematic sectional view showing the state before rotating a supporting member of the workpiece rotation mechanism of the stripping apparatus according to the first embodiment of the invention;

FIG. 13 is a schematic sectional view showing a state in which a rotational pin is engaged with a pin engagement part of a protrusion of the supporting member of the workpiece rotation mechanism of the stripping apparatus according to the first embodiment of the invention;

FIG. 14 is a schematic sectional view showing a state in which the rotational pin has started to rotate the supporting member of the workpiece rotation mechanism of the stripping apparatus according to the first embodiment of the invention;

FIG. 15 is a schematic sectional view showing a state in which the rotational pin is about to finish rotating the supporting member of the workpiece rotation mechanism of the stripping apparatus according to the first embodiment of the invention;

FIG. 16 is a schematic sectional view showing a state in which the rotational pin has finished rotating the supporting member of the workpiece rotation mechanism of the stripping apparatus according to the first embodiment of the invention;

FIG. 17 is a schematic sectional view showing a state in which the rotational pin is at a position retracted from the supporting member after the rotational pin finished rotating the supporting member of the workpiece rotation mechanism of the stripping apparatus according to the first embodiment of the invention;

FIG. 18 is a schematic sectional view of a workpiece rotation mechanism of a stripping apparatus according to the second embodiment of the invention;

FIG. 19 is a schematic sectional view of a workpiece rotation mechanism of a stripping apparatus according to a third embodiment of the invention; and

FIG. 20 is a schematic sectional view of a workpiece rotation mechanism of a stripping apparatus according to a fourth embodiment of the invention.

### DETAILED DESCRIPTION OF THE INVENTION

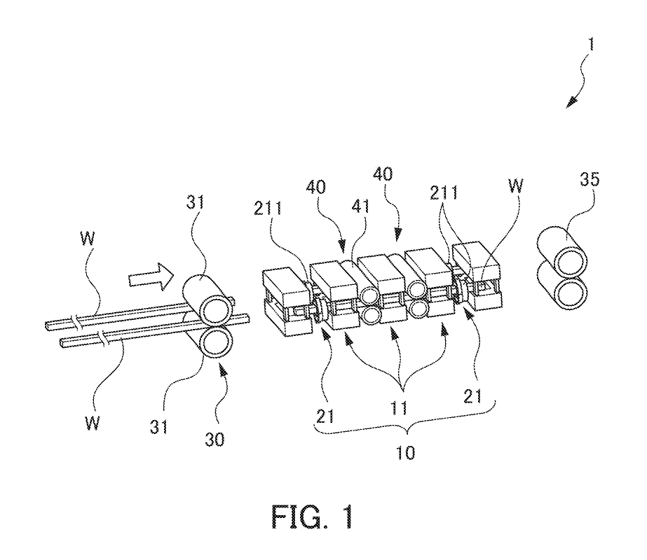

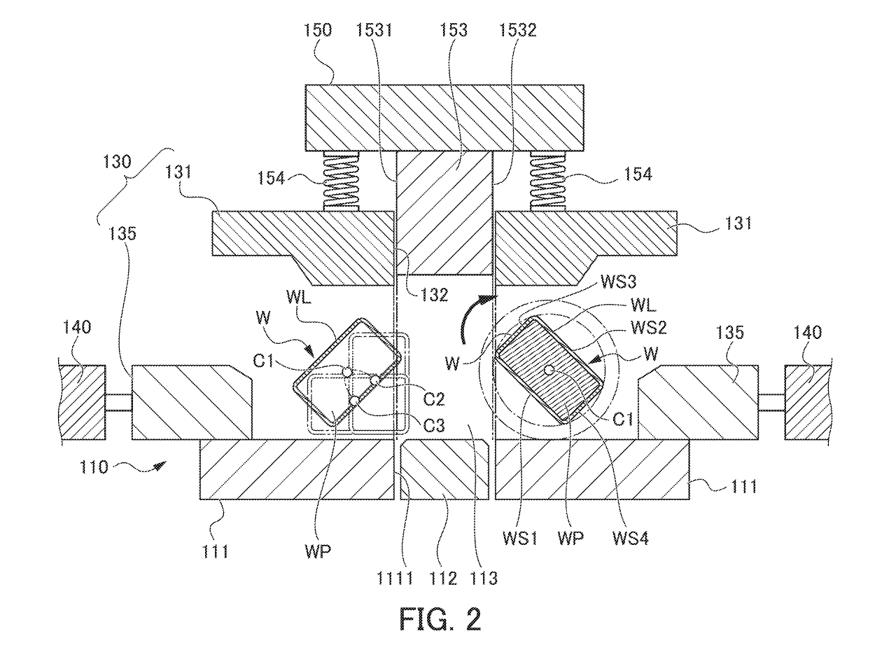

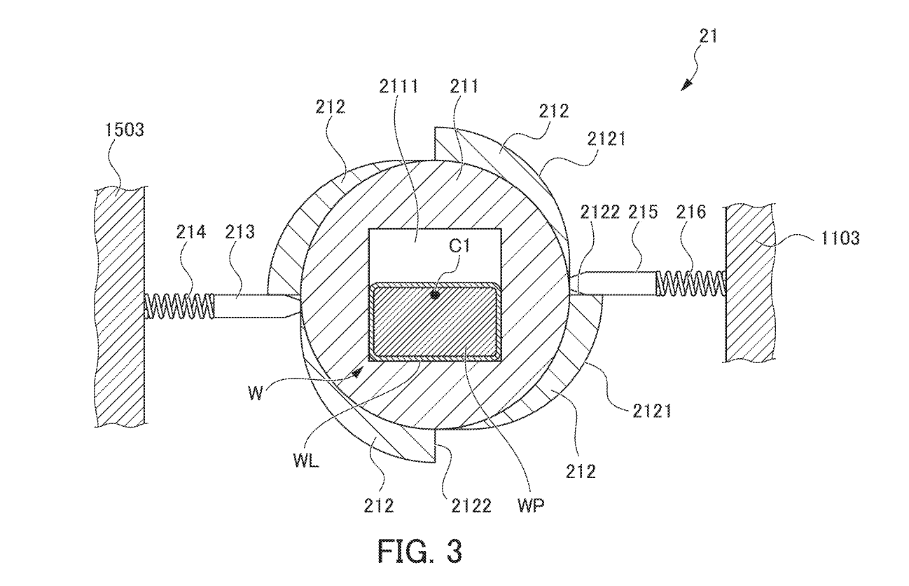

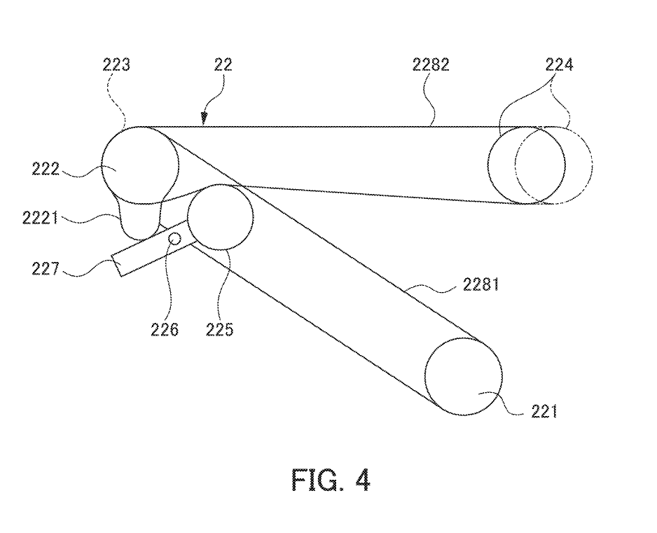

A first embodiment of the invention is described below with reference to the drawings. FIG. 1 is a schematic view of a stripping station according to the first embodiment of the invention. FIG. 2 is a schematic sectional view of a stripping apparatus according to the first embodiment of the invention. FIG. 3 is a schematic sectional view of a workpiece rotation mechanism of the stripping apparatus according to the first embodiment of the invention. FIG. 4 is a schematic sectional view of an eccentric mechanism of the workpiece rotation mechanism of the stripping apparatus according to the first embodiment of the invention. Referring to FIG. 1, a stripping station 1 of this embodiment is used for manufacturing a coil segment which is obtained by stripping the insulation coating WL at both ends of a long workpiece that is the conducting wire material W for a coil that is coated with the insulation coating WL.

A rectangular wire is used as the conducting wire material W. Referring to FIG. 2 and the like, the cross-section of each of the conducting wire materials W (the section orthogonal to the longitudinal direction of the conducting wire material W) has a rectangular shape. Each of the conducting wire materials W includes a first side surface WS1 and a second side surface WS2 respectively corresponding to the long sides of the rectangular shape and a third side surface WS3 and a fourth side surface WS4 respectively corresponding to the short sides of the rectangular shape. Each of the conducting wire materials W includes a conductive part WP formed of copper or the like and an insulation coating WL covering the periphery of the conductive part WP. Each of the conducting wire materials W are stripped of the insulation coating WL and are cut into a predetermined length suitable for a coil segment by the stripping station 1. A large number of the conducting wire materials W are in stock while being aligned by a palletizing device (not shown).

Referring to FIG. 1, the stripping station 1 includes a stripping apparatus 10 with five stripping molds 11 and workpiece rotation mechanisms 21, an upstream roller 30, a downstream roller 35, and intermediate rollers 40. As described above, the conducting wire materials W are cut to a predetermined length suitable for a coil segment, and a number required for manufacturing a coil of the conducting wire materials W each having one of the four predetermined lengths are prepared in advance.

The stripping station 1 includes five stripping molds 11 arranged between the upstream roller 30 and the downstream roller 35 in the direction which is the axial direction of the conducting wire materials W and in which the conducting wire materials W are fed (hereinafter referred to as “feeding direction”). Supporting members 211 of one of the workpiece rotation mechanisms 21 (described below) are disposed between the first one and the second one of the stripping molds 11 counted from the upstream side in the feeding direction, and supporting members 211 of the other one of the workpiece rotation mechanisms 21 are disposed between the fourth one and the fifth one of the stripping molds 11 counted from the upstream side of the feeding direction. One of the intermediate rollers 40 is disposed between the second one and the third one of the stripping molds 11 counted from the upstream side in the feeding direction, and the other one is disposed between the third one and the fourth one of the stripping molds 11 counted from the upstream side. The conducting wire materials W are inserted into the first one of the stripping molds 11, counted from the upstream side, respectively penetrate through holes 2111 of the supporting members 211 (described below) of one of the workpiece rotation mechanisms 21 on the upstream side in the feeding direction, pass through the three stripping molds 11, respectively penetrate through holes 2111 of the supporting members 211 (described below) of the other one of the workpiece rotation mechanisms 21 on the downstream side in the feeding direction, and pass through and are fed out from the fifth one of the stripping molds 11 counted from the upstream side.

The upstream roller 30 includes a pair of rollers 31. The rotation of the pair of rollers 31 allows the conducting wire materials W to pass between the pair of rollers 31 and to be fed to the respective supporting members 211 of one of the workpiece rotation mechanisms 21 through the first one of the stripping molds 11 counted from the upstream side. The downstream roller 35 includes a pair of rollers 36. The rotation of the pair of rollers 36 allows the conducting wire materials W to pass through the fifth one of the stripping molds 11 counted from the upstream side from the supporting members 211 of the other one of the workpiece rotation mechanisms 21 and be sent out from between the pair of rollers 36.

Each of the intermediate rollers 40 includes a pair of rollers 41. The rotation of the pair of rollers 41 allows the conducting wire materials W to pass between the pair of rollers 41 and to be fed to one of the stripping molds 11 on the downstream side of the pair of rollers 41 in the feeding direction.

Referring to FIG. 3, the workpiece rotation mechanism 21 includes a supporting member 211, protrusions 212, a rotational pin 213, a spring 214 as a rotational-pin urging member, a fixed pin 215, and a spring 216 as a fixed-pin urging member, and rotates the conducting wire material W by a predetermined angle around a rotational axis C1 that is parallel to the axial center of the conducting wire material W in synchronization with the upward movement of the upper molds 150 (described below) of the stripping molds 11.

Specifically, the supporting member 211 has a cylindrical outer shape, and has a circular shape in the cross-section orthogonal to the axial center of the supporting member 211 as shown in FIG. 3. The supporting member 211 is supported by a lower mold 110 such that the axial center of the supporting member 211 is movable. The movement of the axial center of the supporting member 211 is performed by an eccentric mechanism (described later).

The supporting member 211 includes a square-shaped through hole 2111 at the center thereof. The through hole 2111 penetrates the supporting member 211 in the feeding direction, and into which the conducting wire material W, which has been fed from the upstream roller 30, is inserted. Accordingly, the upstream ends of the two conducting wire materials W are respectively inserted into the two supporting members 211 disposed upstream of the five stripping molds 11 in the feeding direction, and the downstream ends of the two conducting wire materials W are respectively inserted into the two supporting members 211 disposed downstream of the five stripping molds 11 in the feeding direction, whereby the two conducting wire materials W are supported in parallel, and the conducting wire materials W supported in parallel are subjected to stripping of the insulation coatings WL performed by the stripping molds 11.

The length of one side of the through hole 2111 shown in FIG. 3 is slightly longer than the long sides of the rectangular shape of the conducting wire material W. The conducting wire material W inserted into the through hole 2111 is held by the supporting member 211 in a state in which the conducting wire material W is movable inside the through hole 2111 with respect to the supporting member 211 but is non-rotatable with respect to the supporting member 211. The supporting member 211 is supported in a rotatable manner integrally with the conducting wire material W around the rotational axis C1 that is the axial center of the supporting member 211, while supporting the conducting wire material W in the through hole 2111.

The workpiece rotation mechanism 21 includes an eccentric mechanism 22. When the supporting member 211 rotates integrally with the conducting wire material W, the eccentric mechanism 22 temporarily moves the supporting member 211 such that the axial center of the supporting member 211 is decentered to axial centers C2, C3 from the axial center position at the time of stripping the insulation coating WL of the conducting wire material W, as described below. Since the supporting member 211 is temporarily moved by the eccentric mechanism 22, the conducting wire material W can rotate without contacting die 111 of the stripping molds 11, side-surface pressing members 135, and the like (described below).

Specifically, the eccentric mechanism 22 includes a plurality of belts 2281, 2282, a plurality of pulleys 221, 222, 223, 224, and a belt pressing pulley 225 (see FIG. 4). The belt 2281 is wound around the pulley 221 and the pulley 222, and the belt 2282 is wound around the pulley 223 and the pulley 224.

The pulley 224 is provided on the supporting member 211 such that the pulley 224 is rotatable with respect to the supporting member 211 and the axial center of the pulley 224 is movable integrally with the supporting member 211. The pulley 222 and the pulley 223 are fixed to the same rotation shaft and rotate integrally with each other. The pulley 223 includes a cam 2221 at a position outside the belt 2282. The cam 2221 protrudes from a part of the circumference of the pulley 222 in the radially outward direction of the pulley 222. The pulley 221 is connected to the output shaft of a rotation power device, such as a motor (not shown), and is rotated by driving such a rotation power device.

The belt pressing pulley 225 is rotatably supported by one end of a swinging member 227 swingable around a swinging shaft 226, and the circumferential surface of the belt pressing pulley 225 is in contact with the belt 2282. The other end of the swinging member 227 can come into contact with the cam 2221. As the pulley 222 rotates and the cam 2221 comes into contact with the swinging member 227, the swinging member 227 rotates around the swinging shaft 226, so that the belt pressing pulley 225 presses the belt 2282 upward in FIG. 4, thereby moving the pulley 224 and the supporting member 211 in a direction toward the rotation shaft of the pulley 222 (in the direction from the pulley 224 indicated by a chain double-dashed line to the pulley 224 indicated by a solid line). This moves the conducting wire material W supported by the supporting member 211 away from the die 111 and conducting-wire-material abutting walls 113, so that the supporting member 211 can be rotated by the rotational pin 213 while supporting the conducting wire material W.

Referring to FIG. 3 and the like, four protrusions 212 are provided on the circumferential surface of the supporting member 211, and each of the protrusions 212 protrudes from the circumferential surface of the supporting member 211 in the radially outward direction of the supporting member 211. The four protrusions 212 have the same shape and are provided at intervals of a center angle of 90° around the rotational axis C1 of the circular supporting member 211 shown in FIG. 3. One of the protrusions 212 is provided in the center angle range of from 0° to 90° of the supporting member 211 shown in FIG. 3 (in a range from 12 o'clock to 3 o'clock, considering the circular supporting member 211 shown in FIG. 3 as the face of a clock), in which the protruded amount of the supporting member 211 in the radially outward direction gradually increases as the center angle approaches 0° (at the 12 o'clock position) from 90°, and is the smallest (i.e. approximately zero) at the center angle of 90° (at the 3 o'clock position) and the largest at the center angle of 0° (at the 12 o'clock position). In the same manner, the other protrusions 212 are provided in a center angle range of from 360° (0°) to 270° (9 o'clock position), a center angle range of from 270° to 180° (6 o'clock position), and a center angle range of from 180° to 90° of the supporting member 211 shown in FIG. 3, in which the protruded amount gradually increases as the center angle becomes smaller, in the same manner as in the center angle range of from 90° to 0°. The supporting members 211 included in the stripping apparatus 10 have the same shape. In other words, while the supporting member 211 shown in FIG. 3 rotates clockwise, each of the protrusions 212 has a pin sliding surface 2121 extending radially outwardly, away from the rotational axis C1 of the supporting member 211 gradually from the downstream side to the upstream side of the rotation direction of the conducting wire material W.

Each of the protrusions 212 includes a pin engagement part 2122. Specifically, the upstream end of the pin sliding surface 2121 in the rotation direction of the supporting member 211 is the end of each of the four protrusions 212, which are provided on the circumferential surface of the supporting member 211, and is connected to the surface directing radially inwardly of the supporting member 211 to form a corner part. Each of the protrusions 212 at the corner part has a shape falling radially inwardly of the supporting member 211 and being cut away (a cut-away shape), and the cut-away shaped part forms the pin engagement part 2122. The pin engagement part 2122 can be engaged with the rotational pin 213 or a fixed pin 215 as shown in FIG. 3.

The rotational pin 213 is supported by the upper mold 150 of the stripping mold 11 so as to move back and forth with respect to the supporting member 211, and moves vertically in synchronization with the vertical movement of the upper mold 150 of the stripping molds 11. Specifically, as shown in FIG. 3, the tip end of the rotational pin 213 has a truncated cone shape, and the base part thereof has a cylindrical shape. The base end of the base part is fixed with one end of the spring 214 serving as a rotational-pin urging member. The other end of the spring 214 is fixed to a holder 1503 provided on the upper mold 150. The spring 214 urges the rotational pin 213 toward the supporting member 211. Thus, the tip end of the rotational pin 213 abuts against and slides on the pin sliding surface 2121 of one of the protrusions 212 of the supporting member 211, or is engaged with the pin engagement part 2122. The rotational pin 213 is supported by the holder 1503 provided on the upper mold 150 so as to move up and down integrally with the upper mold 150.

The fixed pin 215 is supported by the lower mold 110 of the stripping mold 11 so as to move back and forth with respect to the supporting member 211, and the vertical position of the fixed pin 215 is fixed relative to the lower mold 110 of the stripping mold 11 and the supporting member 211. Specifically, the tip end of the fixed pin 215 has a truncated cone shape, and the base part thereof has a cylindrical shape. The base end of the base part is fixed with one end of the spring 216 serving as a fixed-pin urging member. The other end of the spring 216 is fixed to a holder 1103 provided on the lower mold 110. The spring 216 urges the fixed pin 215 toward the supporting member 211. Thus, the tip end of the fixed pin 215 abuts against the pin sliding surface 2121 of the protrusion 212 of the supporting member 211, or is engaged with the pin engagement part 2122. As shown in FIG. 3, the fixed pin 215 is engaged with the pin engagement part 2122, thereby preventing counterclockwise rotation of the supporting member 211 in FIG. 3. The fixed pin 215 is supported by the holder 1103 of the lower mold 110 so that the fixed pin 215 can prevent the rotation of the supporting member 211 in a state in which the pin engagement part 2122 is engaged with the tip end of the fixed pin 215.

Each of the stripping molds 11 includes the lower mold 110, a pressing member 130, and an upper mold 150. The lower mold 110 includes a die 111 and a center guide 112. The die 111 extends in the axial direction of the conducting wire materials W, and includes a through hole 1111 penetrating the die 111 in the vertical direction. The die 111 extends in the axial direction of the conducting wire materials W, and the center guide 112 is disposed in the through hole 1111 penetrating the die 111 in the vertical direction. When a punch 153 of the upper mold 150 moves below the upper surface of the die 111, the center guide 112 moves in the vertical direction in synchronization with the movement of the punch 153.

Referring to FIG. 2, two conducting wire materials W, which are respectively supported by the supporting members 211, are disposed on the upper surface of the die 111 on both the sides of the through hole 1111. The die 111 of the lower mold 110 supports the lower sides of the conducting wire materials W. The conducting-wire-material abutting walls 113 extending in the vertical direction are provided on the upstream side and the downstream side in the feeding direction (the direction connecting the front surface and the back surface of the drawing plane of FIG. 2) of the center guide 112. The width in the direction orthogonal to both the feeding direction and the vertical direction (i.e. in the left-right direction in FIG. 2, hereinafter referred to as “cross-sectional direction”) of each of the conducting-wire-material abutting walls 113 is equal to the width in the same direction of the through hole 1111, in which the center guide 112 is disposed, and the conducting wire materials W are pressed by the respective side-surface pressing members 135 against the side surfaces in the same direction of the conducting-wire-material abutting walls 113, at the time of stripping the insulation coatings WL of the conducting wire materials W.

The upper molds 150 of the five stripping molds 11 are connected to an upper mold driving unit including a cylinder, an actuator, and the like (not shown) such that all the five upper molds 150 can simultaneously move in the vertical direction with respect to the lower molds 110. The punch 153 serving as a stripping blade and a cutting blade to strip the insulation coating WL is fixed to the lower surface of each of the upper molds 150. Thus, the punch 153 moves integrally with the corresponding upper mold 150 in the vertical direction, which is the direction orthogonal to the axial direction of the conducting wire materials W.

The punch 153 has an approximately rectangular parallelepiped shape. A pair of two side surfaces 1531, 1532 in the left-right direction (cross-sectional direction) in FIG. 2 of the punch 153 are configured to simultaneously strip the insulation coatings WL of the conducting wire materials W placed on the die 111. In other words, each of the pair of two side surfaces 1531, 1532 in the left-right direction (cross-sectional direction) in FIG. 2 of the punch 153 moves downward along the side surface (any one of a first side surface WS1, a second side surface WS2, a third side surface WS3, and a fourth side surface WS4) of the conductive part WP of the corresponding rectangular shaped conducting wire material W to cut off and strip the insulation coating WL of the corresponding conducting wire material W. This cutting-off process is performed simultaneously with respect to the two conducting wire materials W placed on the respective die 111.

A pair of springs 154 as elastic members are provided with the upper ends thereof being fixed to the lower surface of the upper mold 150. The lower ends of the pair of springs 154 are fixed to the upper surface of the upper-surface pressing member 131 included in the pressing member 130, and the pair of springs 154 urge the upper-surface pressing member 131 in the downward direction with respect to the upper mold 150.

The pressing member 130 is provided to prevent displacement of the conducting wire materials W, and includes the upper-surface pressing member 131 and the side-surface pressing members 135. The upper-surface pressing member 131 is disposed above the conducting wire materials W, which are placed on the die 111, and below the upper mold 150, and is joined to the upper mold 150 through the springs 154 which are elastic members. The upper-surface pressing member 131 includes a through hole 132 and the through hole 132 is penetrated by the punch 153.

The lower end of the punch 153 is disposed to face the center guide 112 disposed in the through hole 1111 of the die 111 of the lower mold 110. As the upper mold 150 moves downward, the upper-surface pressing member 131 moves downward together with the upper mold 150. Then, the lower surface of the upper-surface pressing member 131 comes into contact with the conducting wire materials W and the conducting wire materials W are pressed downward by the urging force of the springs 154, so that the conducting wire materials W are positioned between the upper-surface pressing member 131 and the die 111, thereby preventing rotation of the conducting wire materials W around the respective axial centers.

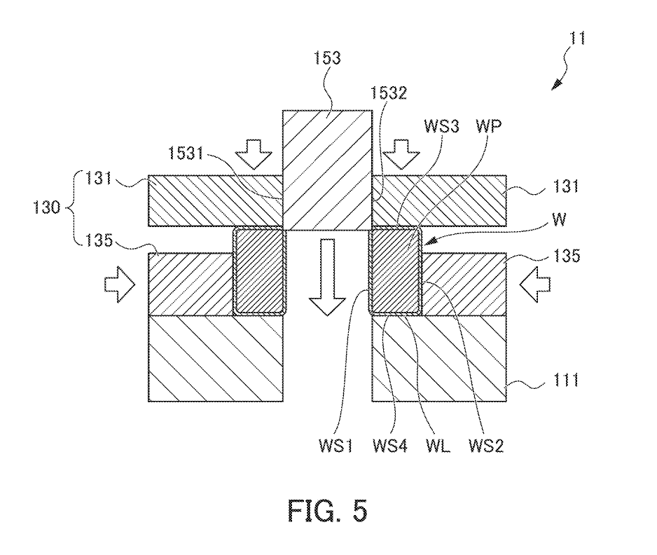

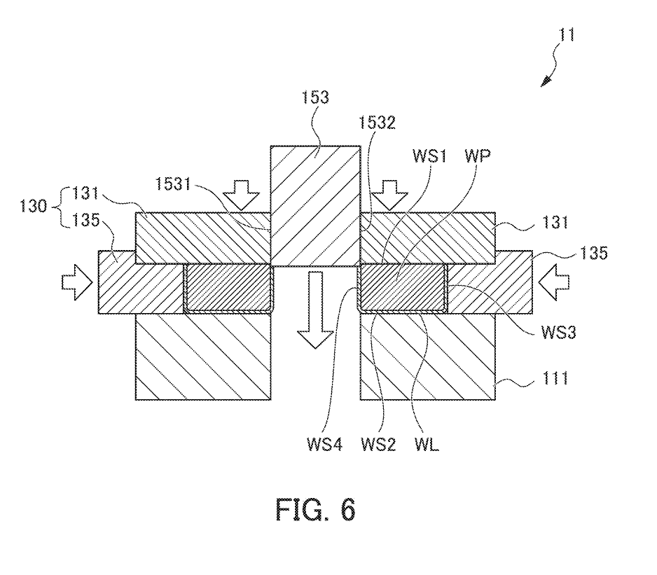

The upper-surface pressing member 131 can change the holding width of the conducting wire materials W in the vertical direction according to the vertical width of the conducting wire materials W. The vertical width of the conducting wire materials W varies depending on whether the conducting wire materials W are disposed so that the cross sections thereof are in a vertically long state as shown in FIG. 5 and the like or in a horizontally long state as shown in FIG. 6 and the like. Nevertheless, the upper-surface pressing member 131 can position the conducting wire materials W in the vertical direction corresponding to the state in which the cross-sections thereof are in a vertically long state or in a horizontally long state, since the upper-surface pressing member 131 is urged downward by the springs 154 with respect to the upper mold 150 and presses the conducting wire materials W from above so that the conducting wire materials W are positioned between the upper-surface pressing member 131 and the die 111.

A pair of side-surface pressing members 135 are provided in the feeding direction and the cross-sectional direction, and are respectively connected to driving mechanisms 140 including a cylinder, an actuator, and the like such that the side-surface pressing members 135 are slidable on the die 111 so as to be separated from/approach each other. The driving mechanisms 140 urge the respective side-surface pressing members 135 in a direction in which the side-surface pressing members 135 come into contact with the respective conducting wire materials W. The pair of side-surface pressing members 135 approach each other, and come into contact with and press the respective conducting wire materials W against the side surfaces of the conducting-wire-material abutting walls 113 so that the conducting wire materials W are positioned in the side surface width direction.

The side-surface pressing members 135 can change the holding width in the side surface width direction of the conducting wire materials W according to the side surface width of the conducting wire materials W. The side surface width of the conducting wire materials W (the width of the conducting wire materials in the cross-sectional direction in FIG. 5 and the like) varies depending on whether the conducting wire materials W are disposed so that the cross-sections thereof are in the vertically long state as shown in FIG. 5 and the like or in the horizontally long state as shown in FIG. 6 and the like. Nevertheless, the side-surface pressing members 135 can position the conducting wire materials W in the side surface width direction corresponding to the state in which the cross-sections thereof are in the vertically long state or in the horizontally long state, since the side-surface pressing members 135 press the respective conducting wire materials W against the side surfaces of the conducting-wire-material abutting walls 113 to position the conducting wire materials W.

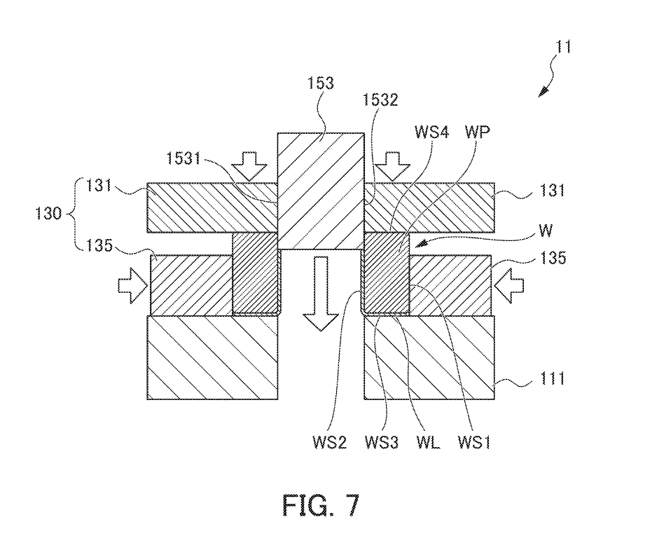

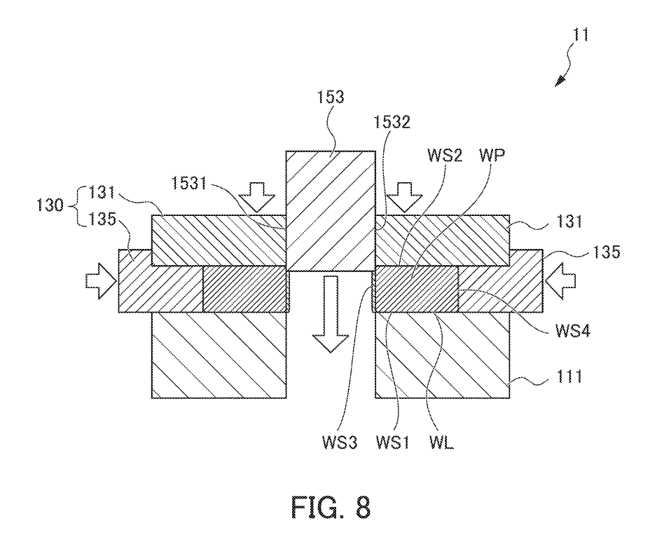

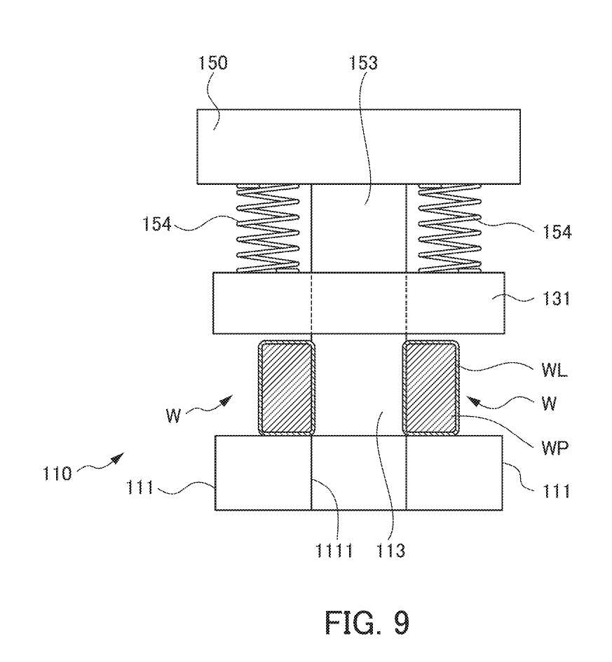

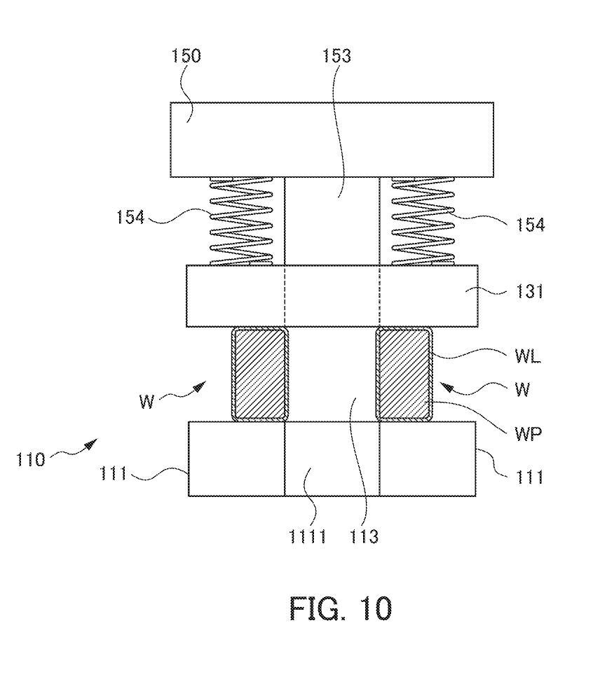

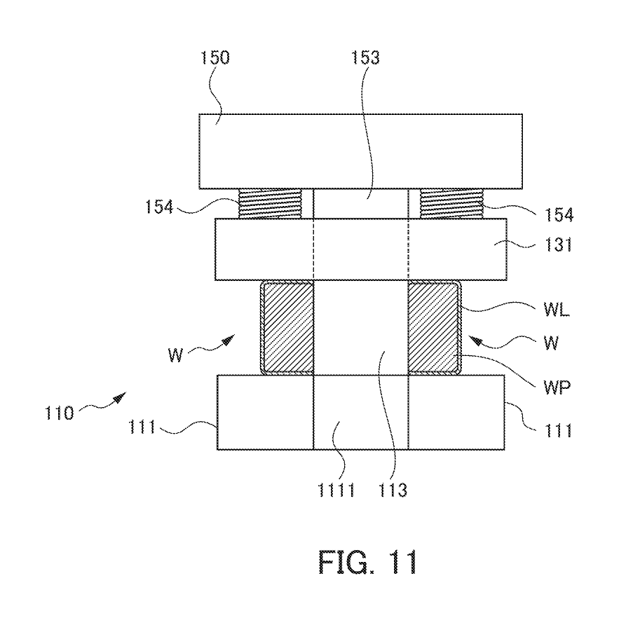

Steps to strip the insulation coatings WL of the conducting wire materials W are now described. A positioning step is first performed with respect to the stripping molds 11. FIG. 5 is a schematic sectional view showing a state in which the stripping apparatus according to the first embodiment of the invention strips insulation coatings on first side surfaces of conducting wire materials. FIG. 6 is a schematic sectional view showing a state in which the stripping apparatus according to the first embodiment of the invention strips insulation coatings on fourth side surfaces of the conducting wire materials. FIG. 7 is a schematic sectional view showing a state in which the stripping apparatus according to the first embodiment of the invention strips insulation coatings on second side surfaces of the conducting wire materials. FIG. 8 is a schematic sectional view showing a state in which the stripping apparatus according to the first embodiment of the invention strips insulation coatings on third side surfaces of the conducting wire materials. FIG. 9 is a schematic sectional view showing the state before positioning the conducting wire materials in the vertical direction when the stripping apparatus according to the first embodiment of the invention strips the insulation coatings on the first side surfaces of the conducting wire materials. FIG. 10 is a schematic sectional view showing the state after positioning the conducting wire materials in the vertical direction when the stripping apparatus according to the first embodiment of the invention strips the insulation coatings on the first side surfaces of the conducting wire materials. FIG. 11 is a schematic sectional view showing a state in which the insulation coatings on the first side surfaces of the conducting wire materials have been stripped by the stripping apparatus according to the first embodiment of the invention.

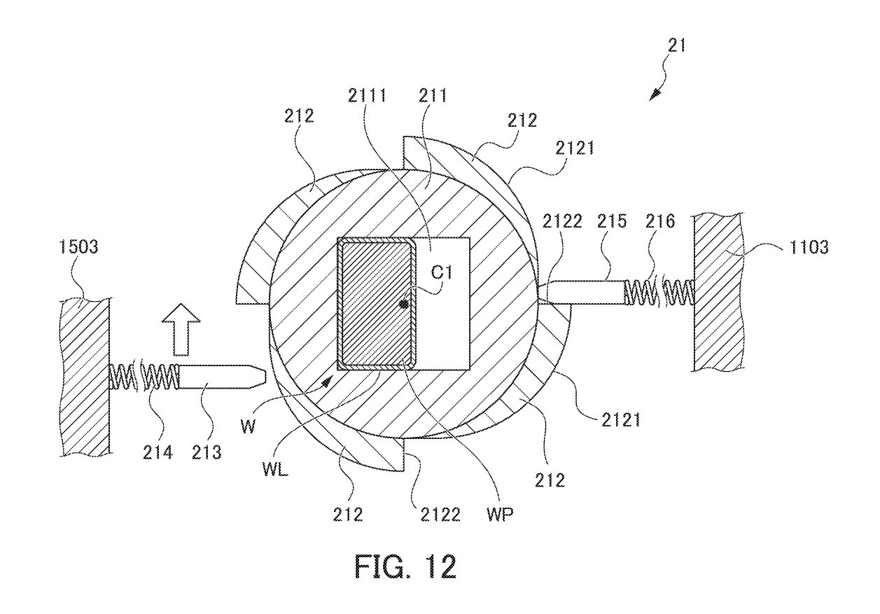

In the positioning step, as shown in FIG. 9 and the like, each of the conducting wire materials W is inserted into the through hole 2111 of the supporting member 211 (see FIG. 12 and the like) in a state in which the cross-section of the conducting wire material W is in the vertically longer state to be supported by the supporting member 211, and is placed on the upper surface of the die 111 of each of the stripping molds 11 so that the fourth side surface WS4 comes into contact with the upper surface of the die 111. Then, as shown in FIGS. 5 and 10, the side-surface pressing members 135 are respectively driven by the driving mechanisms 140 (see FIG. 2) such that each of the side-surface pressing members 135 comes into contact with the second side surface WS2 of the corresponding conducting wire material W, and presses the corresponding conducting wire material W against the conducting-wire-material abutting walls 113 while the first side surface WS1 comes into contact with the conducting-wire-material abutting walls 113 (see FIG. 2), so that each of the conducting wire materials W are held between the conducting-wire-material abutting walls 113 and the corresponding side-surface pressing member 135 to be positioned in the cross-sectional direction. Then, the upper mold driving unit (not shown) is driven to move each of the upper molds 150 downward such that the conducting wire materials W are held between the upper-surface pressing member 131 and the die 111 while the upper-surface pressing member 131 comes into contact with the first side surface WS1. This is the description of the positioning step.

Then, a stripping step is performed. In the stripping step, by further driving the upper mold driving unit (not shown), each of the upper molds 150 is moved downward to allow the punch 153 to be projected from the lower surface of the upper-surface pressing member 131. This causes the pair of two side surfaces in the cross-sectional direction of the punch 153 to start cutting the insulation coatings WL of the first side surfaces WS1, respectively. Then, the insulation coatings WL of the first side surfaces WS1 are cut off and stripped by moving the upper mold 150 downward until the punch 153 reaches the center guide 112 as shown in FIG. 11. This is the description of the stripping step.

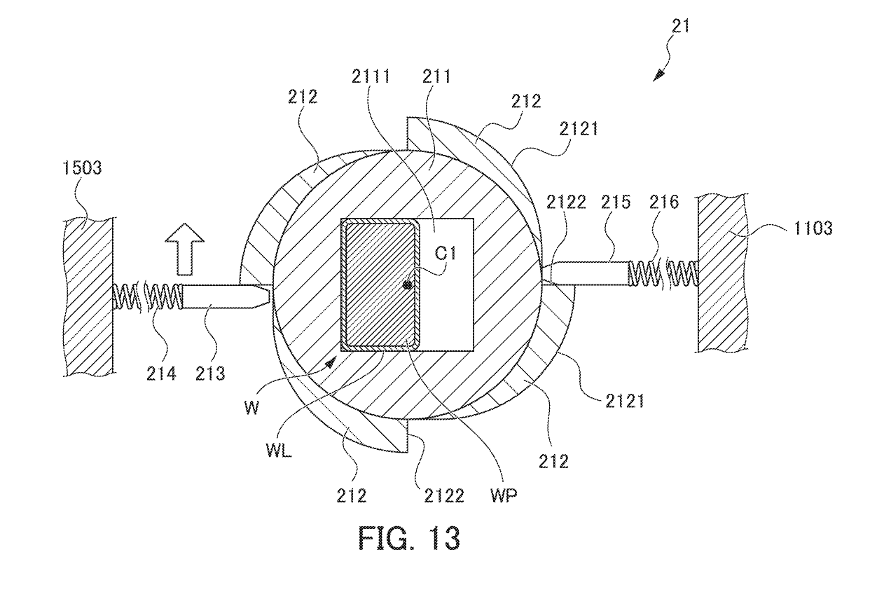

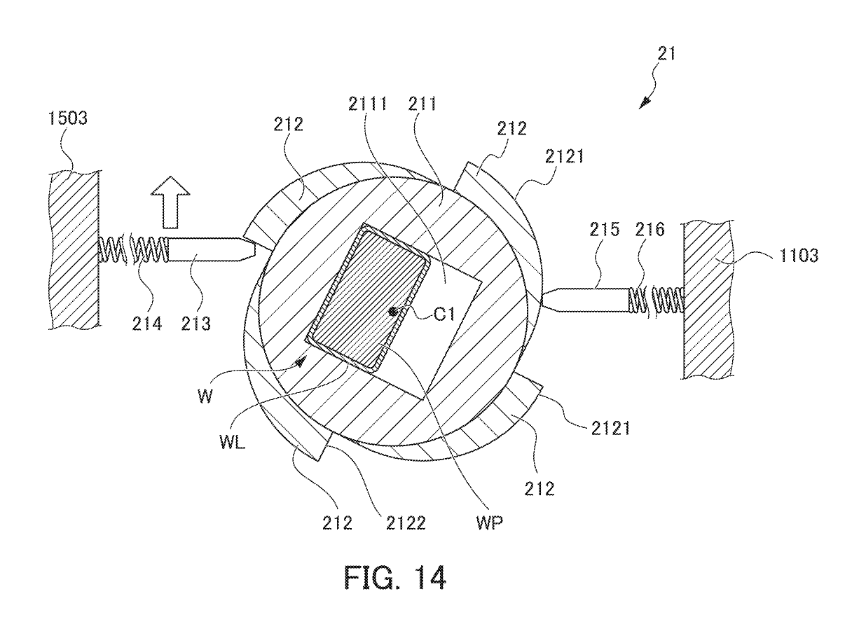

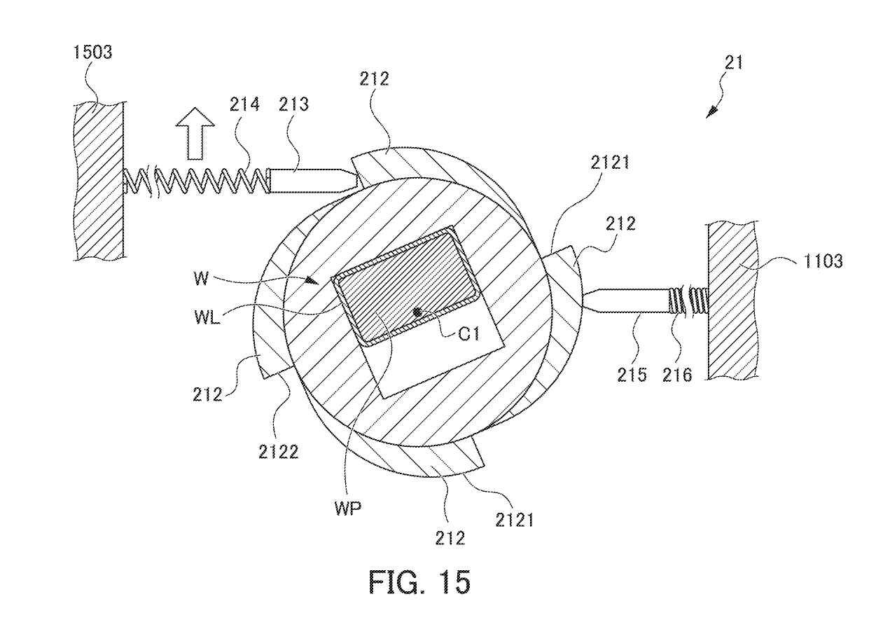

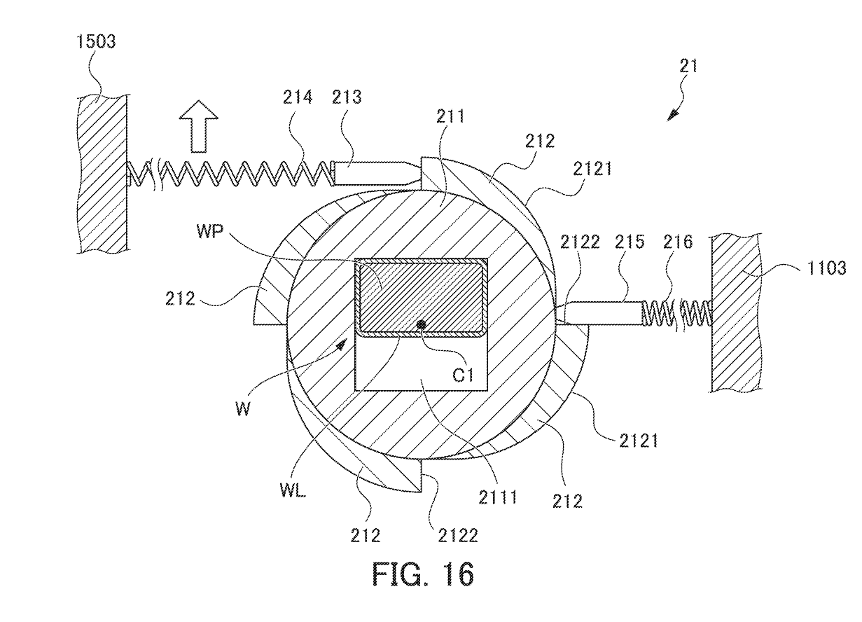

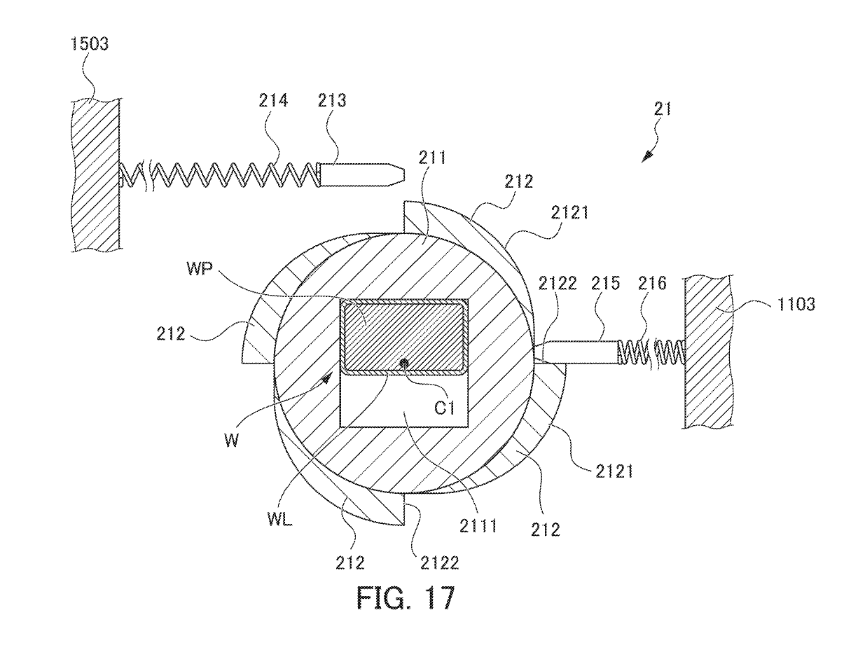

Then, a rotation step is performed. FIG. 12 is a schematic sectional view showing the state before rotating a supporting member of the workpiece rotation mechanism of the stripping apparatus according to the first embodiment of the invention. FIG. 13 is a schematic sectional view showing a state in which a rotational pin is engaged with a pin engagement part of a protrusion of the supporting member of the workpiece rotation mechanism of the stripping apparatus according to the first embodiment of the invention. FIG. 14 is a schematic sectional view showing a state in which the rotational pin has started to rotate the supporting member of the workpiece rotation mechanism of the stripping apparatus according to the first embodiment of the invention. FIG. 15 is a schematic sectional view showing a state in which the rotational pin is about to finish rotating the supporting member of the workpiece rotation mechanism of the stripping apparatus according to the first embodiment of the invention. FIG. 16 is a schematic sectional view showing a state in which the rotational pin has finished rotating the supporting member of the workpiece rotation mechanism of the stripping apparatus according to the first embodiment of the invention. FIG. 17 is a schematic sectional view showing a state in which the rotational pin is at a position retracted from the supporting member after the rotational pin has finished rotating the supporting member of the workpiece rotation mechanism of the stripping apparatus according to the first embodiment of the invention.

In the rotation step, the driving mechanisms 140 (see FIG. 2) are driven such that the pair of side-surface pressing members 135 are moved away from each other in the cross-sectional direction and separated from the second surfaces of the respective conducting wire materials W. Then, the upper mold 150, which has been moved downward until the punch 153 reaches the center guide 112, is moved upward. This moves the upper-surface pressing member 131 away from the third side surfaces of the conducting wire materials W, and also moves the rotational pin 213 upward as shown in FIG. 12. Then, the axial center position of each of the supporting members 211 is shifted by the eccentric mechanism 22 from the axial center position C2 (see FIG. 2) of the supporting member 211 in the stripping step to the axial center position C1.

The upper mold 150 is moved further upward, then the tip end of the rotational pin 213 is engaged with one of the pin engagement parts 2122, as shown in FIG. 13. Then, a further upward movement of the upper mold 150 causes the tip end of the rotational pin 213 to push one of the protrusions 212 upward as shown in FIG. 14, thereby rotating the supporting member 211. A still further upward movement of the upper mold 150 causes the supporting member 211 to rotate by 90° (one-fourth rotation) from the state shown in FIG. 13 (see FIGS. 15 to 16). Then, the upper mold 150 reaches the top dead center as shown in FIG. 9, whereby the engagement of the rotational pin 213 with the pin engagement part 2122 is released as shown in FIG. 17. Then, the axial center position of each of the supporting members 211 is shifted by the eccentric mechanism 22 from the axial center position C1 (see FIG. 2), around which the supporting member 211 has been rotated, to the axial center position C3. This is the description of the rotation step. After the rotation step, the second side surfaces WS2 of the conducting wire materials W are in contact with the upper surface of the die 111.

The positioning step, the stripping step, and the rotation step are repeated in the same manner as described above, whereby the insulation coatings WL of the fourth side surfaces WS4, the second side surfaces WS2, the third side surfaces WS3 of the conducting wire materials W are stripped in this order.

This embodiment achieves the following effects.

According to this embodiment, the stripping apparatus 10 configured to strip the insulation coatings WL of the conducting wire materials W, each including the insulation coatings WL and each of the cross-sections of which orthogonal to the longitudinal direction has a square shape, includes the upper molds 150 each having the punch 153 as a stripping blade for stripping the insulation coatings WL, the lower molds 110 supporting the conducting wire materials W from the lower side thereof, the pressing members 130 preventing displacement of the conducting wire materials W, and the workpiece rotation mechanisms 21 configured to rotate the conducting wire materials W around the rotational axes C1 parallel to the axial centers of the conducting wire materials W.

With this configuration, the conducting wire materials W as workpieces are rotated by a predetermined angle during the process of stripping the insulation coatings WL, thus only the stroke time for moving the molds 11 and the time for rotating the conducting wire materials are included in the standby time in which no processing is performed, thereby reducing the cycle time. In other words, the time for rotating a conducting wire material W by a predetermined angle is shorter than the time for feeding a conducting wire material W in the axial direction. As described above, the stripping device according to the embodiment rotates the conducting wire material W by a predetermined angle instead of feeding a conducting wire material W in the axial direction, thereby reducing the cycle time for the process of stripping the insulation coating WL of a conducting wire material W.

In addition, the punch 153 as a stripping blade has a substantially rectangular shape, and at least a pair of two opposing faces are configured to strip the insulation coatings WL. The two faces 1531, 1532 having the striping function are capable of striping the insulation coatings WL of two conducting wire materials W simultaneously. With this configuration, two conducting wire materials W can be processed simultaneously, thereby enhancing the processing efficiency.

Each of the pressing members 130 includes the side-surface pressing members 135 that can change the holding width in the side surface width direction of the conducting wire materials W according to the side surface width of the conducting wire material W, and the upper-surface pressing member 131 that can change the holding width of the conducting wire materials W in the vertical direction.

In the case where the cross-section of the conducting wire material W has a rectangular shape for example, the width dimension in the cross-sectional direction of the conducting wire material W varies when the conducting wire material W is rotated, and the distance between the side-surface pressing member 135 and the conducting wire material W also varies. In addition, the width dimension in the vertical direction (height dimension) of the conducting wire material W varies, and the distance between the upper-surface pressing member 131 and the conducting wire material W also varies. Nevertheless, the conducting wire material W can be reliably positioned and fixed even when the width dimension of the conducting wire material W varies, since the side-surface pressing members 135 and the upper-surface pressing member 131 are movable.

The stripping apparatus according to this embodiment further includes driving mechanisms 140 configured to respectively urge the side-surface pressing members 135 in a direction in which the side-surface pressing members 135 respectively come into contact with the conducting wire materials W. With this configuration, the driving mechanisms 140 cause the side-surface pressing members 135 to come into contact with the conducting wire materials W respectively, whereby the positions of the conducting wire materials W can be easily fixed even when the conducting wire materials W have different widths.

The upper-surface pressing member 131 is joined to the upper mold 150 through the springs 154 serving as elastic members. This enables the upper-surface pressing member 131 to move in the vertical direction by utilizing the strokes of the upper mold 150 to be separated from/approach the lower mold 110. At this time, even when the upper mold 150 continues to approach the lower mold 110, the movement of the upper-surface pressing member 131 can be stopped at the position where the upper-surface pressing member 131 comes into contact with the conducting wire materials W by utilizing the elasticity of the springs 154. This eliminates the need for a driving mechanism, such as a servomotor.

According to the stripping station 1 of the embodiment, a plurality of the stripping molds 11 having the upper molds 150, the lower molds 110, and the pressing members 130 are aligned in the axial direction of the conducting wire materials W. This makes it possible to simultaneously strip a plurality of places of the conducting wire material W, thereby enhancing the processing efficiency.

The stripping apparatus 10 according to the embodiment configured to strip the insulation coatings WL of the conducting wire materials W as long workpieces, the outer peripheries of which are coated with the insulation coatings WL serving as a coating film, includes the punch 153 as a cutting blade configured to move up and down in the vertical direction which is the direction orthogonal to the axial direction of the conducting wire materials W, the upper molds 150 each having the punch 153, the lower molds 110 supporting the conducting wire materials W, the workpiece rotation mechanisms 21 configured to rotate the conducting wire materials W by a predetermined angle around the rotational axes C1 parallel to the axial centers of the conducting wire materials W in synchronization with the upward movement of the upper molds 150.

With this configuration, the conducting wire materials W as workpieces are rotated by a predetermined angle during the time for the upward movement of the punch 153 as a cutting blade or the time for the processing, thus only the stroke time for moving the molds 11 and the time for rotating the conducting wire materials are included in the standby time in which no processing is performed, thereby reducing the cycle time.

The workpiece rotation mechanism 21 according to the embodiment includes the supporting member 211 rotatable while supporting the conducting wire material W as a workpiece, the rotational pin 213 configured to move vertically in synchronization with the vertical movement of the upper molds 150, the springs 214 serving as a rotational-pin urging member configured to urge the rotational pin 213 toward the supporting member 211, the fixed pin 215 the vertical position of which is fixed relative to the supporting member 211, the spring 216 serving as a fixed-pin urging member configured to urge the fixed pin 215 toward the supporting member 211, the protrusions 212 provided on the periphery of the supporting member 211, each of which includes a pin sliding surface 2121 extending radially outwardly, away from the rotational axis C1 of the supporting member 211 gradually from the downstream side to the upstream side of the rotation direction of the workpiece, and cut-away shaped pin engagement parts 2122 disposed at the upstream end of the pin sliding surface 2121 in the rotation direction of the supporting member 211 and configured to engage with the rotational pin 213 or the fixed pin 215.

With this configuration, when the upper mold 150 moves upward, the rotational pin 213 moves upward in synchronization with the movement of the upper mold 150. The rotational pin 213 presses the pin engagement part 2122 upward to rotate the supporting member 211. While the fixed pin 215 slides along the pin sliding surface 2121, the spring 216 serving as a fixed-pin urging member is compressed, then the fixed pin 215 is engaged with the pin engagement part 2122 to prevent backflow (backward rotation of the supporting member 211). The rotation of the supporting member 211 stops and the upper mold 150 and the rotational pin 213 are lowered. Each of the conducting wire materials W as a workpiece is subjected to the processing again at the rotated position so that a side surface different from the side surface that has been processed is processed. In other words, the movement of the upper mold 150 and the rotation of the conducting wire material W can be synchronized with each other with a simple configuration. The rotation angle can be adjusted by changing the number of the protrusions 212 and the size of the supporting member 211.

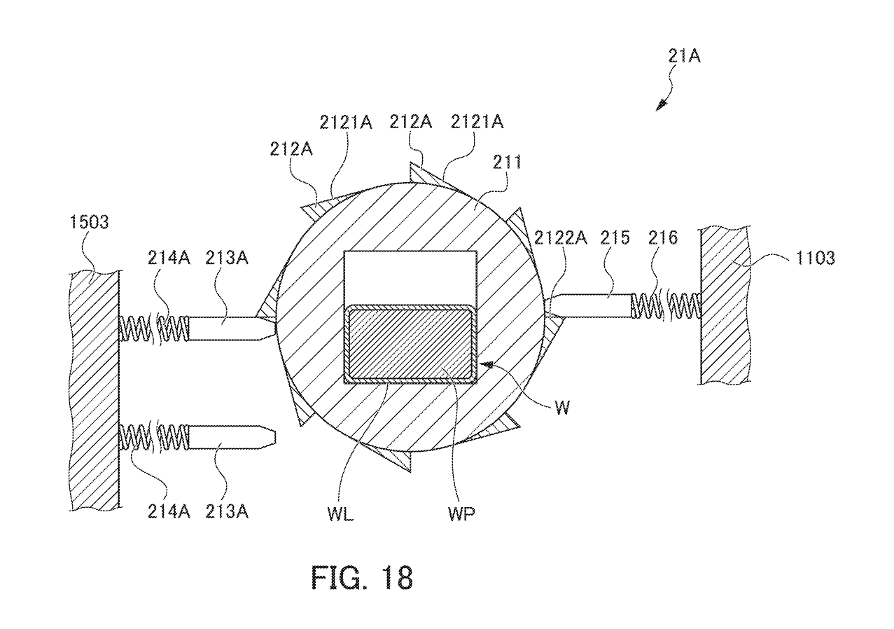

The second embodiment of the invention is described below with reference to the drawings. The components the same as those of the first embodiment are denoted with the same reference numerals, and the detailed description thereof is omitted. The second embodiment differs from the first embodiment in the configuration of protrusions 212A of a workpiece rotation mechanism 21A and the configuration of a rotational pin 213A. FIG. 18 is a schematic sectional view of a workpiece rotation mechanism of a stripping apparatus according to a second embodiment of the invention.

Eight protrusions 212A are provided on the supporting member 211 in the circumferential direction at regular intervals. A pin sliding surface 2121A of each of the protrusions 212A extends in the tangential direction of the supporting member 211 from the downstream side to the upstream side of the rotation direction of the supporting member 211 (clockwise direction in FIG. 18). Two rotational pins 213A are provided, and each of the rotational pins 213A is urged by a spring 214A. The vertical distance between the two rotational pins 213A and the distance from the two rotational pins 213A to the protrusions 212A are set such that the two rotational pins 213A are respectively engaged with pin engagement parts 2122A of two of the protrusions 212A adjacent to each other in the circumferential direction of the supporting member 211 when the upper molds 150 moves in the upward direction from the bottom dead center, which is the lowermost position of the upper molds 150. This configuration reduces the stroke amount in which the rotational pins 213A move back and forth with respect to the supporting member 211, as compared with the first embodiment.

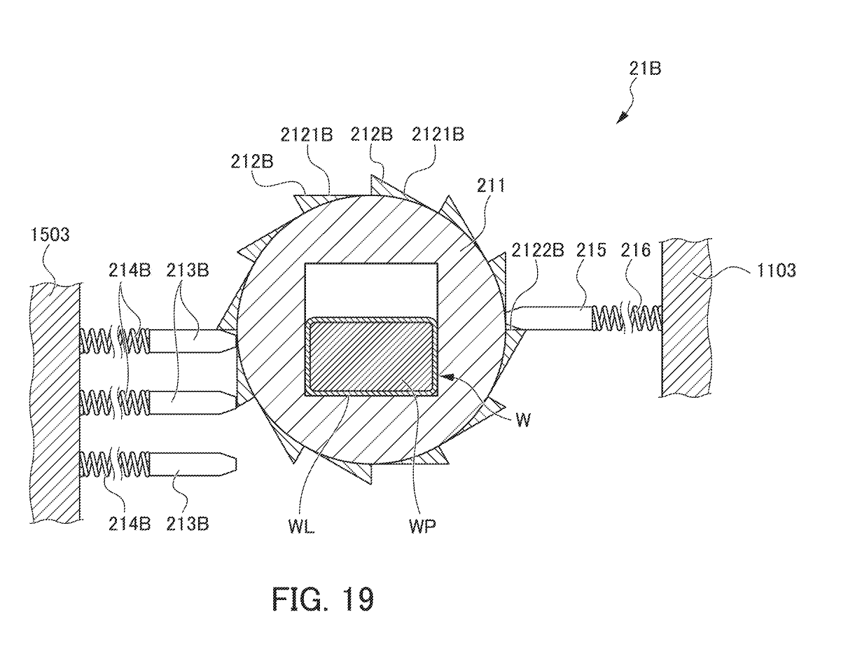

The third embodiment of the invention is described below with reference to the drawings. The components the same as those of the first embodiment are denoted with the same reference numerals, and the detailed description thereof is omitted. The third embodiment differs from the first embodiment in the configuration of protrusions 212B of workpiece rotation mechanism 21B and the configuration of the rotational pins 213B. FIG. 19 is a schematic sectional view of a workpiece rotation mechanism of a stripping apparatus according to the third embodiment of the invention.

Twelve protrusions 212B are provided on the supporting member 211 in the circumferential direction at regular intervals. A pin sliding surface 2121B of each of the protrusions 212B extends in the tangential direction of the supporting member 211 from the downstream side to the upstream side of the rotation direction of the supporting member 211. Three rotational pins 213B are provided, and each of the rotational pins 213B is urged by a spring 214B. The vertical intervals among the three rotational pins 213B and the distance from the three rotational pins 213B to the protrusions 212B are set such that the three rotational pins 213B are respectively engaged with pin engagement parts 2122B of three of the protrusions 212B adjacent to one another in the circumferential direction of the supporting member 211 when the upper molds 150 move in the upward direction from the bottom dead center, which is the lowermost position of the upper molds 150. This configuration further reduces the stroke amount in which the rotational pins 213B move back and forth with respect to the supporting member 211, as compared with the first and the second embodiments.

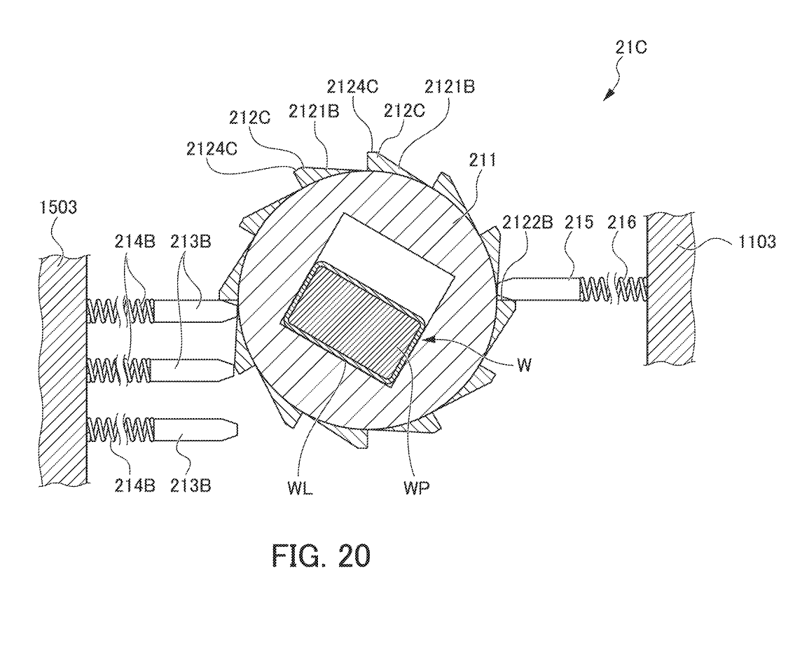

The fourth embodiment of the invention is described below with reference to the drawings. The components the same as those of the first to third embodiments are denoted with the same reference numerals, and the detailed description thereof is omitted. The fourth embodiment differs from the third embodiment in the configuration of the protrusions 212C of the workpiece rotation mechanism 21C. FIG. 20 is a schematic sectional view of a workpiece rotation mechanism of a stripping apparatus according to the fourth embodiment of the invention.

The tip end of each of the protrusions 212C has a tip flat surface 2124C. The tip flat surface 2124C is a plane orthogonal to the radius of the supporting member 211. All the distances from the center of the supporting member 211 to the tip flat surfaces 2124C are equal, and the tip flat surfaces 2124C of all the protrusions 212C have the same shape and the same area. The tip flat surfaces 2124C provided on the tip ends of the protrusions 212C allow the rotational pins 213B and the fixed pin 215 to be smoothly engaged with the pin engagement parts 2122B as compared with the protrusions 212B of the third embodiment, thereby preventing damage or hock to the rotational pins 213B and the fixed pin 215.

The present invention is not limited to the above embodiments, and variations, improvements, and the like capable of achieving the object of the invention are intended to be within the scope of the invention. For example, each of the conducting wire materials W has a rectangular-shaped cross-section, but is not limited thereto. The cross-section of each of the conducting wire materials W may have any quadrilateral shape, such as a trapezoid. The insulation coatings WL of two conducting wire materials W are stripped simultaneously, but the number of the conducting wire materials W is not limited to two. A pair of two side surfaces 1531, 1532 in the cross-sectional direction of the punch 153 are configured to strip the insulation coatings WL of the conducting wire materials W simultaneously, but the configuration is not limited thereto. Any stripping blade having at least a pair of two opposing faces that can strip the insulation coatings WL may be used. The workpiece rotation mechanism is not limited to the workpiece rotation mechanism 21 of the above embodiments. For example, the supporting member 211 rotates in synchronization with the upward movement of the upper molds 150, but the configuration is not limited thereto. Any configuration that can rotate the conducting wire materials W by a predetermined angle around the rotational axes C1, which are parallel to the axial center of the conducting wire materials W as workpieces, in synchronization with the upward and/or downward movement of the upper molds 150 may be employed. The upper-surface pressing member 131 is supported by the upper mold 150 through the springs 154, but the configuration is not limited thereto. For example, the motor may drive the upper surface pressing part relative to the upper mold 150. The configuration of each component of the stripping apparatus is not limited to that of the stripping apparatus 10 of the above embodiments. The configuration of each component of the stripping station is not limited to that of the stripping station 1 of the above embodiments.

### EXPLANATION OF REFERENCE NUMERALS

1 stripping station
10 stripping apparatus
21 workpiece rotation mechanism (rotation mechanism)
110 lower mold
130 pressing member
131 upper-surface pressing member
135 side-surface pressing member
140 driving mechanism
150 upper mold
153 punch (stripping blade)
154 spring
1531, 1532 two side surfaces (two faces)
C1 axial center position (rotational axis)
W conducting wire material (workpiece)
WL insulation coating (coating film)

What is claimed is:

1. A stripping apparatus configured to strip a film off a long workpiece of which outer periphery is coated with the film, the stripping apparatus comprising:
a cutting blade configured to move up and down in a direction orthogonal to an axial direction of the workpiece;
an upper mold having the cutting blade;
a lower mold supporting the workpiece; and
a workpiece rotation mechanism configured to rotate the workpiece by a predetermined angle around a rotational axis parallel to an axial center of the workpiece in synchronization with an upward movement and/or a downward movement of the upper mold.

2. The stripping apparatus according to claim 1, wherein the workpiece rotation mechanism comprises:
a supporting member that is rotatable while supporting the workpiece;
a rotational pin configured to move vertically in synchronization with a vertical movement of the upper mold;
a rotational-pin urging member configured to urge the rotational pin toward the supporting member;
a fixed pin of which vertical position is fixed relative to the supporting member;
a fixed-pin urging member configured to urge the fixed pin toward the supporting member; and
protrusions provided on a periphery of the supporting member, each of the protrusions including: a pin sliding surface extending radially outwards, away from a rotational axis of the supporting member gradually from a downstream side to an upstream side of a rotation direction of the workpiece; and a cut-away shaped pin engagement part disposed at an upstream end of the pin sliding surface in a rotation direction of the supporting member and configured to engage with the rotational pin or the fixed pin.
